(19) United States
(12) Patent Application Publication
(10) Pub. No.: US 2016/0114692 A1
(43) Pub. Date: Apr. 28, 2016

(54) BATTERY CHARGING DEVICES, BATTERY CHARGING METHODS, BATTERY SYSTEMS, AND METHODS FOR CONTROLLING BATTERIES

(71) Applicant: NANYANG TECHNOLOGICAL UNIVERSITY, Singapore (SG)

(72) Inventors: Anshuman Tripathi, Singapore (SG); Jyothi Nirupam, Singapore (SG)

(21) Appl. No.: 14/895,833

(22) PCT Filed: Jun. 6, 2014
(86) PCT No.: PCT/SG2014/000265

§ 371 Date: Dec. 3, 2015

Related U.S. Application Data
(60) Provisional application No. 61/831,922, filed on Jun. 6, 2013.

(51) Int. Cl. B60L 11/18

(52) U.S. Cl. CPC B60L 11/1816; B60L 11/182

(57) ABSTRACT

According to various embodiments, a battery charging device may be provided. The battery charging device may include: a first determination circuit configured to determine a state of a first battery of an electric vehicle; a second determination circuit configured to determine a state of a second battery of the electric vehicle; a first charging circuit configured to charge the first battery based on the determined condition of the first battery; and a second charging circuit configured to charge the second battery based on the determined condition of the second battery.

### CROSS-REFERENCE TO RELATED APPLICATIONS

The present application claims the benefit of the U.S. provisional patent application No. 61/831,922 filed on 6 Jun. 2013, the entire contents of which are incorporated herein by reference for all purposes.

### TECHNICAL FIELD

Embodiments relate generally to battery charging devices, battery charging methods, battery systems, and methods for controlling batteries.

### BACKGROUND

Electric vehicles are currently being deployed as environment friendly vehicles for transportation as an alternative to the conventional combustion engine vehicles. Thus, there may be a need for an effective charging method of batteries used in the electric vehicles.

### SUMMARY

According to various embodiments, a battery charging device may be provided. The battery charging device may include: a first determination circuit configured to determine a state of a first battery of an electric vehicle; a second determination circuit configured to determine a state of a second battery of the electric vehicle; a first charging circuit configured to charge the first battery based on the determined condition of the first battery; and a second charging circuit configured to charge the second battery based on the determined condition of the second battery.

According to various embodiments, a battery charging method may be provided. The battery charging method may include: determining a state of a first battery of an electric vehicle; determining a state of a second battery of the electric vehicle; charging the first battery based on the determined condition of the first battery; and charging the second battery based on the determined condition of the second battery.

According to various embodiments, a battery system may be provided. The battery system may include: a first battery; a second battery; a configurable interconnection; and a switching circuit configured to switch the configurable interconnection between the first battery and the second battery.

According to various embodiments, a method for controlling batteries may be provided. The method may include: switching a configurable interconnection between a first battery and a second battery.

### BRIEF DESCRIPTION OF THE DRAWINGS

In, the drawings, like reference characters generally refer to the same parts throughout the different views. The drawings are not necessarily to scale, emphasis instead generally being placed upon illustrating the principles of the invention. In the following description, various embodiments are described with reference to the following drawings, in which:

FIG. 1 shows a diagram illustrating a cell voltage over time, a capacity over time, and a charge current over time;

FIG. 2A and FIG. 2B show a battery charging devices according to various embodiments;

FIG. 2C shows a flow diagram illustrating a battery charging method according to various embodiments;

FIG. 2D shows a battery system according to various embodiments;

FIG. 2E shows a flow diagram illustrating a method for controlling batteries according to various embodiments;

FIG. 3 shows an illustration of an arrangement of an on board system and an electric vehicle supply equipment according to various embodiments;

FIG. 4 shows a further illustration of an on-board module according to various embodiments;

FIG. 5, FIG. 6, and FIG. 7 show electric vehicles according to various embodiments;

FIG. 8 shows a plugging system according to various embodiments;

FIG. 9 shows a charger system according to various embodiments;

FIG. 10 shows an illustration of a connection between an electric vehicle charging unit and an electric vehicle according to various embodiments;

FIG. 11 shows an electric vehicle according to various embodiments;

FIG. 12 shows a flow diagram illustrating a charging method according to various embodiments;

FIG. 13 shows an illustration of a connection according to various embodiments; and

FIG. 14 shows an illustration 1400 of an arrangement of an on board system and an electric vehicle supply equipment according to various embodiments.

### DESCRIPTION

Embodiments described below in context of the devices are analogously valid for the respective methods, and vice versa. Furthermore, it will be understood that the embodiments described below may be combined, for example, a part of one embodiment may be combined with a part of another embodiment.

In this context, the battery charging device as described in this description may include a memory which is for example used in the processing carried out in the battery charging device. In this context, the battery system as described in this description may include a memory which is for example used in the processing carried out in the battery system. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

Electric vehicles (EVs) are currently being deployed as environment friendly vehicles for transportation as an alternative to the conventional combustion engine vehicles. According to various embodiments, devices and methods may be provided for an effective charging of batteries, for example used in the electric vehicles.

According to various embodiments, a modular quick charging system with independent charging and controllable driving features may be provided. The system includes a modular configuration of both on-board battery modules and charging station modules which charges the battery pack of an electric vehicle. The method allows for simultaneous charging of multiple battery modules at different C (capacity) rates (for example 1C/2 C/3 C) considering the SOH (state of health) and/or SOC (state of charge) of the battery module. The method allows for combination of wired and wireless charging in a single vehicle.

An electric vehicle (EV) may include a battery pack, motor and electronic controls as part of the Electric Drive system. It may be desired to re-charge the battery pack whenever the electric charge stored in battery becomes low.

The charging may for example be done through the household sockets or the commercial AC supply systems.

Two types of charging systems, for example Level 1 (120V AC charging from standard 15 or 20 A) and Level 2 (208-240 AC charging up to 80 amps, on-board vehicle charger), may be most commonly used at present to charge the system.

The time required for Level 1 may be about 8 to 20 hours and Level 2 may be about 3 to 8 hours, based on the battery pack and SOH.

Charging the battery system may be one of the bottlenecks for large-scale deployment of the electric vehicles, since the conventional combustion engine vehicles can be refueled to full tank in about 10 minutes. But an electric vehicle with level 2 charging may require at least 3 hours to be fully charged. If the battery is not fully charged, the EV user has range anxiety, which results in avoiding of the EV compared to conventional systems.

For heavily urbanized geographical architecture, where in there are more high-rise buildings compared to independent houses, public charging stations may be required to support the wide adoption of EVs.

Charging time may also be a major factor concerning the deployment of EV in public transport vehicles, since the public vehicles like taxis or buses may need to be on-road for a longer time than an end to end private user.

Public transport vehicles may be required to charge their batteries rapidly to improve their availability. At present, such technology may still be in development stage to handle large power levels to achieve charging times that suits taxi applications.

To enable fast charging, Level 3 chargers may be introduced. The Level 3 DC (direct current) charger for fast charging may not be very popular due to limitations of the battery chemistry, longevity concern and high infrastructure cost.

Level 3 charging claims to achieve charging within 20 mins (minutes), but it may not fully charge the battery as analyzed in the following. It may degrade the life of the battery pack severely which may be a major drawback and may also add to cost of replacing the battery system.

In the following, an analysis of Level 3 charging will be provided.

Currently most of the EVs employ Li-ion cells for energy storage systems.

A charging of lithium-ion battery may typically include two main stages: a constant current (CC) stage and a constant voltage (CV) stage.

In the CC stage, the battery may be charged by a constant current until a predetermined threshold level is reached.

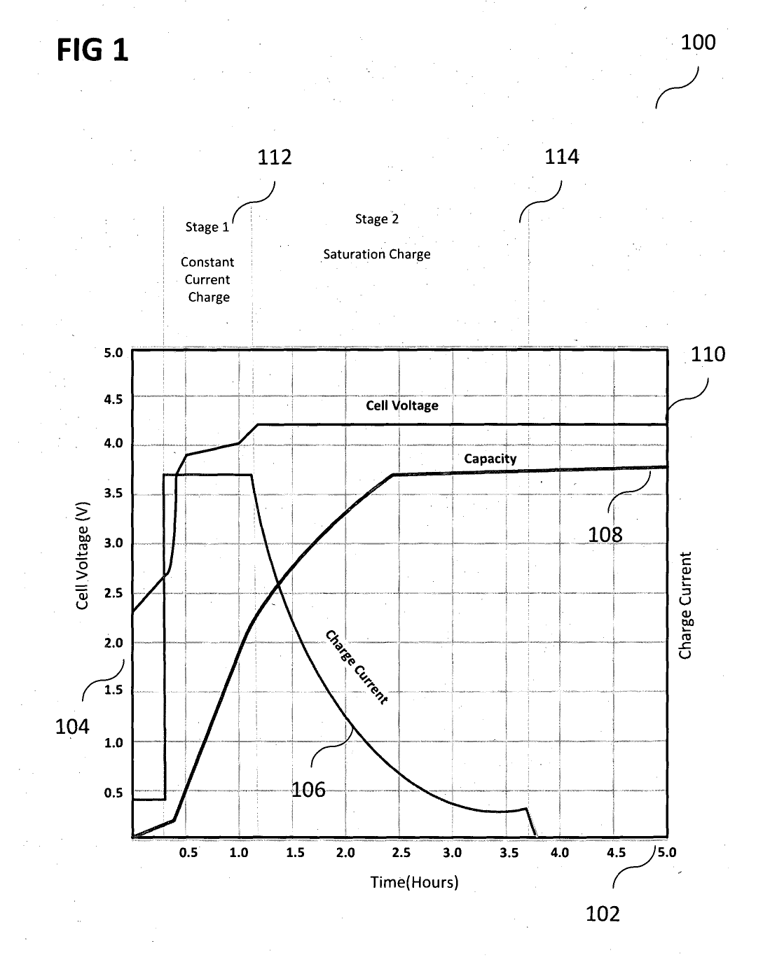

The CV stage may be as follows: When the battery threshold voltage has been reached, the charging stage is switched to supply a constant voltage. From this point the voltage may be kept constant, until the current is reduced below the threshold given by the manufacturer. At the end of this stage, the battery may be considered to be fully charged. In lieu of trickle charge, a topping charge may be applied when the voltage drops to 4.05V/cell. The charging stages, voltage, current characteristics and capacity of a typical lithium cell are depicted in FIG. 1.

FIG. 1 shows a diagram 100 illustrating a cell voltage 110 over time 102 (wherein the amount of the cell voltage is illustrated by axis 104), a capacity 108 over time 102, and a charge current 106 over time 102 during a first state 112 (with a constant current charge) and a second state 2 (with a saturation charge).

The charge rate of a typical consumer Li-ion battery may be between 0.5 and 1 C (capacity) in CC Stage; but during a 30-minute charge from a three-phase 440V outlet, charging may be achieved by increasing the charge current at above 1 C. In this case, the battery may reach the voltage peak quicker (CC stage) with a fast charge, but the CV stage may take longer accordingly. So the amount of charge current applied may alter the time required for each stage; CC stage may be shorter but the CV stage may take longer.

A high current charge may, however, quickly fill the battery to about 70 percent. Li-ion battery may not need full charge, so it may continue to operate, but may result in a short runtime, since the state-of-charge (SOC) at this point may be not 100 percent. So fast charging may not hasten the full-charge state by much.

Apart from the above shortcomings, to accept fast charging, the battery must be designed to accept the high current, and handling of current may pose limitation with many pack designs.

The individual cells in the pack may have to be balanced and in good condition. Older batteries with high internal resistance may heat up; they may no longer be suitable for fast charging.

Fast charging may pose lot of challenges to the charging system and the batteries and may not solve the problem of charging time and cost. This may open up the need for alternative solutions for practical applications of charging system for electric vehicles, to cater to daily transport needs.

Moreover, standards are not available for such level of charging. Wireless charging may also gain attention to charge the electric vehicles, however it does not address issue with the charging time and the cost.

According to various embodiments, devices and methods may be provided for a quick charging system for electric vehicles.

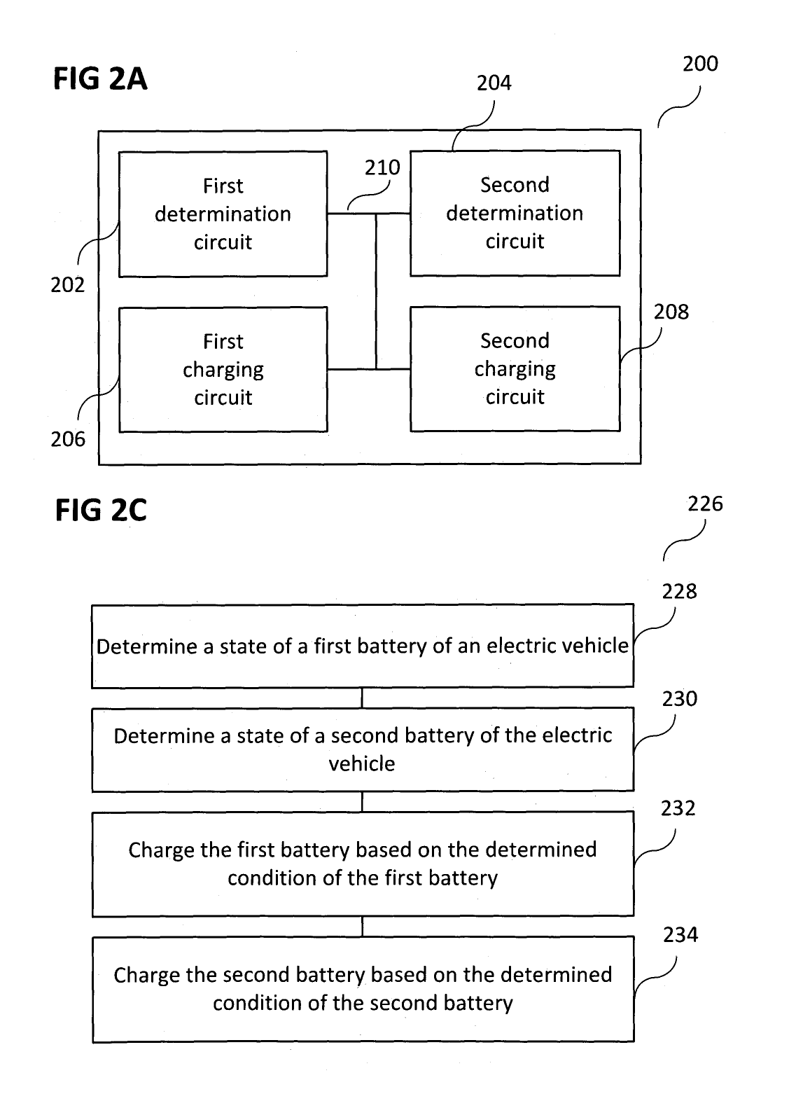

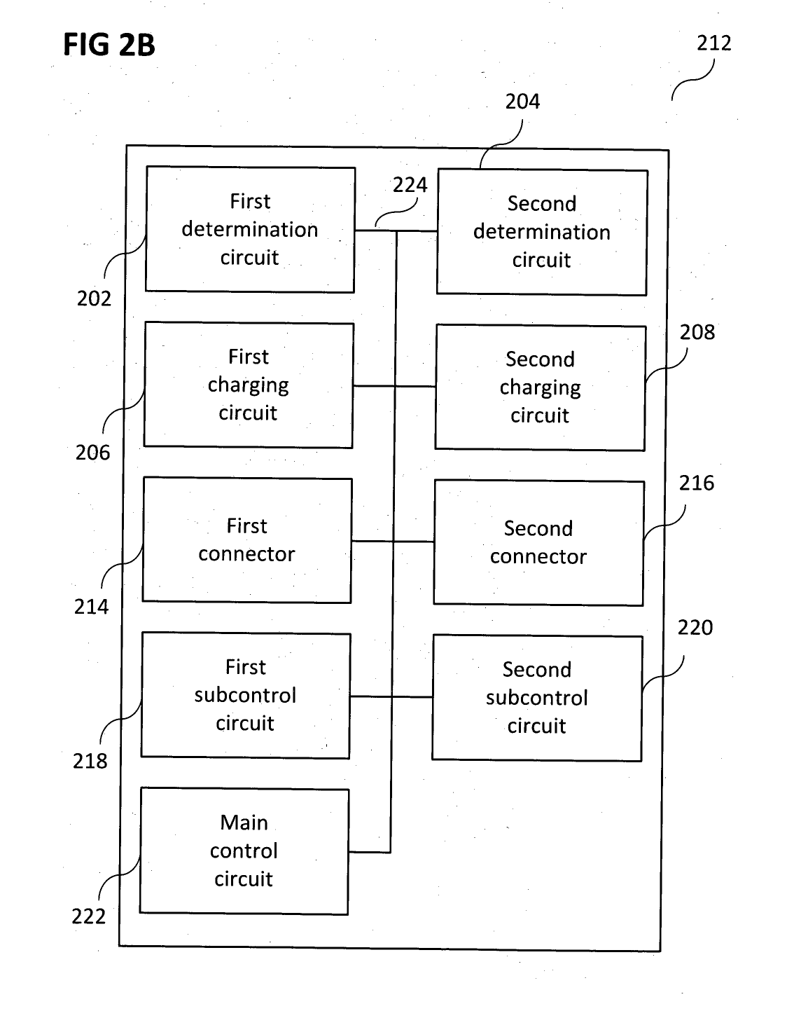

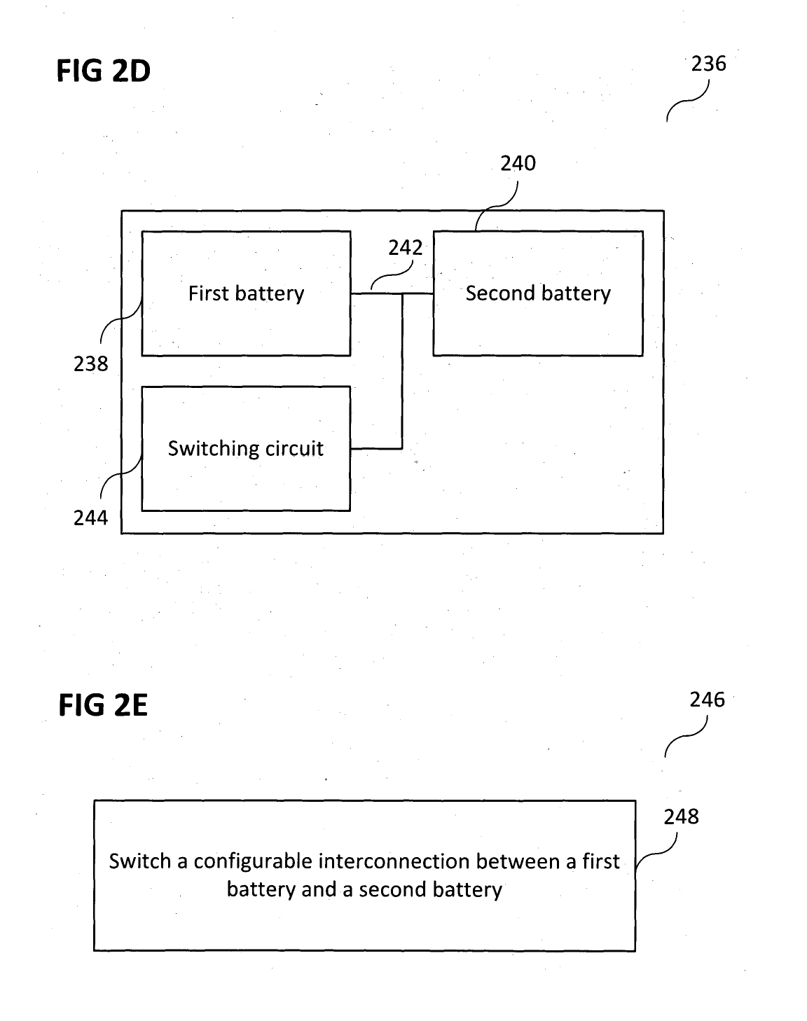

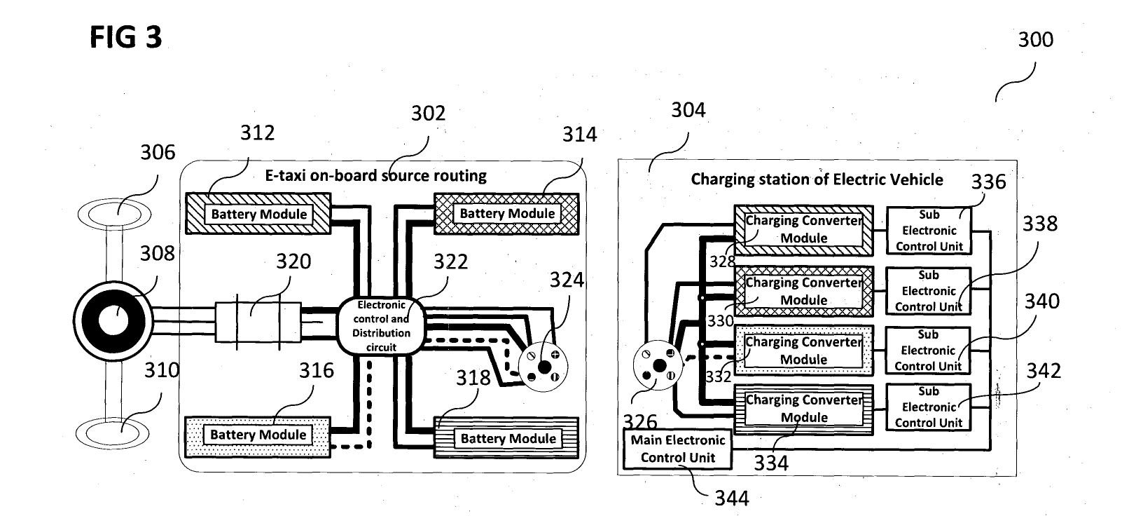

FIG. 2A shows a battery charging device 200 according to various embodiments. The battery charging device 200 may include a first determination circuit configured to determine a state of a first battery of an electric vehicle. The battery charging device 200 may further include a second determination circuit 204 configured to determine a state of a second battery of the electric vehicle. The battery charging device 200 may further include a first charging circuit 206 configured to charge the first battery based on the determined condition of the first battery. The battery charging device 200 may further include a second charging circuit 208 configured to charge the second battery based on the determined condition of the second battery. The first determination circuit 202, the second determination circuit 204, the first charging circuit 206, and the second charging circuit 208 may be coupled by a coupling 210, for example by an electrical coupling or by an optical coupling, for example a cable or a bus.

It will be understood that although two determination circuits and two charging circuits are shown in FIG. 2A, any number of determination circuits (and a corresponding number of charging circuits) may be provided. In other words, each determinations circuit of a plurality of determinations circuits may determine a state of a battery (of a plurality of batteries that are provided in an electric vehicle for driving the vehicle) and a plurality of charging circuits may charge the plurality of batteries accordingly.

According to various embodiments, the state of the first battery may include or may be a state of health of the first battery and/or a state of charge of the first battery. The state of the second battery may include or may be a state of health of the second battery and/or a state of charge of the second battery.

According to various embodiments, the first determination circuit 202 and the second determination circuit 204 may be configured to operate simultaneously.

According to various embodiments, the first charging circuit 206 and the second charging circuit 208 may be configured to operate simultaneously.

According to various embodiments, the first charging circuit 206 may be configured to charge the first battery through a wired connection (in other words: through a physical connection). According to various embodiments, the second charging circuit 208 may be configured to charge the second battery through a wireless medium.

According to various embodiments, the first charging circuit 206 may be configured to determine a first charging power based on the determined condition of the first battery. The first charging circuit 206 may further be configured to charge the first battery with the determined first charging power. The second charging circuit 208 may be configured to determine a second charging power based on the determined condition of the second battery. The second charging circuit 208 may further be configured to charge the second battery with the determined second charging power.

According to various embodiments, the first charging circuit 206 and the second charging circuit 208 may be configured to operate with different charging power.

FIG. 2B shows a battery charging device 212 according to various embodiments. The battery charging device 212 may, similar to the battery charging device 200 shown in FIG. 2A, include a first determination circuit configured to determine a state of a first battery of an electric vehicle. The battery charging device 212 may, similar to the battery charging device 200 shown in FIG. 2A, further include a second determination circuit 204 configured to determine a state of a second battery of the electric vehicle. The battery charging device 212 may, similar to the battery charging device 200 shown in FIG. 2A, further include a first charging circuit 206 configured to charge the first battery based on the determined condition of the first battery. The battery charging device 212 may, similar to the battery charging device 200 shown in FIG. 2A, further include a second charging circuit 208 configured to charge the second battery based on the determined condition of the second battery. The battery charging device 212 may further include a first connector 214, like will be described in more detail below. The battery charging device 212 may further include a second connector 216, like will be described in more detail below. The battery charging device 212 may further include a first subcontrol circuit 218, like will be described in more detail below. The battery charging device 212 may further include a second subcontrol circuit 220, and the main control circuit 222, like will be described in more detail below. The first determination circuit 202, the second determination circuit 204, the first charging circuit 206, the second charging circuit 208, first connector 214, second connector 216, first subcontrol circuit 218, second subcontrol circuit 220, and the main control circuit 222 may be coupled by a coupling 224, for example by an electrical coupling or by an optical coupling, for example a cable or a bus.

According to various embodiments the first connector 214 may be configured to provide a connection between the first battery and the first charging circuit 206. The second connector 216 may be configured to provide a connection between the second battery and the second charging circuit 208.

According to various embodiments, the main control circuit 222 may be configured to control the first determination circuit 202, the second determination circuit 204, the first charging circuit 206, and the second charging circuit 208.

According to various embodiments, the first charging circuit 206 may include or may be a first converter circuit configured to convert an input electric source to a charging signal for the first charging circuit 206. The second charging circuit 208 may include or may be a second converter circuit configured to convert the input electric source to a charging signal for the second charging circuit 208.

According to various embodiments, the first subcontrol circuit 218 may be configured to control the first determination circuit 202 and the first charging circuit 206. The second subcontrol circuit 220 may be configured to control the second determination circuit 204 and the second charging circuit 208.

According to various embodiments, a battery system may be provided. The battery system may include: a battery charging device (for example like described above); the first battery; the second battery; a configurable interconnection; and a switching circuit configured to switch the configurable interconnection between the first battery and the second battery.

According to various embodiments, the battery system may further include a memory configured to store instructions for controlling the switching circuit.

According to various embodiments, the battery system may further include a display interface configured to display a status of the first battery, a status of the second battery, and a status of the switchable interconnection.

According to various embodiments, the battery system may further include a keyboard interface configured to receive user input for individually controlling charging of the first battery and charging of the second battery.

FIG. 2C shows a flow diagram 226 illustrating a battery charging method according to various embodiments. In 228, a state of a first battery of an electric vehicle may be determined. In 230, a state of a second battery of the electric vehicle may be determined. In 232, the first battery may be charged based on the determined condition of the first battery. In 234, the second battery may be charged based on the determined condition of the second battery.

According to various embodiments, the state of the first battery may include or may be a state of health of the first battery and/or a state of charge of the first battery. The state of the second battery may include or may be a state of health of the second battery and/or a state of charge of the second battery.

According to various embodiments, determining the state of the first battery and determining the state of the second battery may be performed simultaneously.

According to various embodiments, charging the first battery and charging the second battery may be performed simultaneously.

According to various embodiments, charging the first battery may be performed through a wired connection. According to various embodiments, charging the second battery may be performed through a wireless medium.

According to various embodiments, the method may further include: determining a first charging power based on the determined condition of the first battery; charging the first battery with the determined first charging power; determining a second charging power based on the determined condition of the second battery; and charging the second battery with the determined second charging power.

According to various embodiments, the first charging power may be different from the second charging power.

According to various embodiments, the method may further include: providing a first connection between the first battery and the first charging circuit; and providing a second connection between the second battery and the second charging circuit.

According to various embodiments, the method may further include: controlling the first determination circuit, the second determination circuit, the first charging circuit, and the second charging circuit using a main control circuit.

According to various embodiments, the method may further include: converting an input electric source to a first charging signal for charging the first battery; and converting the input electric source to a second charging signal for charging the second battery.

According to various embodiments, the method may further include: controlling the first determination circuit and the first charging circuit using a first subcontrol circuit; and controlling the second determination circuit and the second charging circuit using a second subcontrol circuit.

According to various embodiments, the battery charging method may further include switching a configurable interconnection (for example inter-bank module connections, like will be described in more detail below) between the first battery and the second battery.

According to various embodiments, the battery charging method may further include storing instructions for controlling the switching circuit.

According to various embodiments, the battery charging method may further include displaying a status of the first battery, a status of the second battery, and a status of the switchable interconnection.

According to various embodiments, the battery charging method may further include receiving user input for individually controlling charging of the first battery and charging of the second battery.

FIG. 2D shows a battery system 236 according to various embodiments. The battery system 236 may include a first battery 238. The battery system 236 may further include a second battery 240. The battery system 236 may further include a configurable interconnection 242 (for example inter-bank module connections, like will be described in more detail below). The battery system 236 may further include a switching circuit 244 configured to switch the configurable interconnection between the first battery and the second battery.

In other words, batteries may be disconnected from series configuration during charging. For example, the power distribution to each battery module may be determined based on the state of heath of the battery.

According to various embodiments, the battery system 236 may further include a battery charging device (for example a battery charging device like described above; not shown in FIG. 2D).

According to various embodiments, the battery system 236 may further include a memory (not shown in FIG. 2D) configured to store instructions for controlling the switching circuit 244.

According to various embodiments, the battery system may further include a display interface (not shown in FIG. 2D) configured to display a status of the first battery 238, a status of the second battery 240, and a status of the switchable interconnection 242.

According to various embodiments, the battery system 236 may further include a keyboard interface (not shown in FIG. 2D) configured to receive user input for individually controlling charging of the first battery 238 and charging of the second battery 240.

According to various embodiments, the switching circuit 244 may include or may be digital control logics.

FIG. 2E shows a flow diagram 246 illustrating a method for controlling batteries according to various embodiments. In 248, a configurable interconnection may be switched between a first battery and a second battery.

According to various embodiments, the method may further include a battery charging method (for example like described above).

According to various embodiments, the method may further include storing instructions for controlling the switching of the configurable interconnection.

According to various embodiments, the method may further include displaying a status of the first battery, a status of the second battery, and a status of the switchable interconnection.

According to various embodiments, the method may further include receiving user input for individually controlling charging of the first battery and charging of the second battery.

According to various embodiments, the method may further include switching the configurable interconnection between the first battery and the second battery using digital control logics.

According to various embodiments, devices and methods may be provided for solving the problem with the charging time for plug-in electric vehicle battery systems. The devices and methods may also be provided for maintaining and/or enhancing the state of health of the battery pack.

The electric vehicle charging system may include an off-board charging unit (which may also be referred to as electric vehicle supply equipment (EVSE)) and an on-board charging system, which may charge the battery pack of an electric vehicle.

Various embodiments relates to modularizing the on-board battery modules and accordingly configuring the electric vehicle supply equipment to charge the battery system. The on-board individual modular battery units may be charged simultaneously by the EVSE.

Various embodiments may be implemented with the existing technology and available components to foster the electric vehicle deployment.

The quick charging system for electric vehicles according to various embodiments may charge the electric vehicles sooner (in other words: faster) than commonly used charging systems by three times at least.

The system according to various embodiments may include a modular bank of RESS (Rechargeable Energy storage system), for example battery modules, and a smart charging control unit with communication interface in the electric vehicle. The system may also include multiple DC sources and the smart charging control and communication interface module at the EVSE (Electric vehicle Supply Equipment) to cater to the charging requirements of individual battery banks.

The power transfer between the EVSE and the on-board unit may be achieved through wired or wireless connectivity. According to various embodiments, plug-in (or the wired connection) and/or wireless charging may be provided. To ensure on the modularity according to various embodiments, multiple connection points (in case of plug-in systems) and coils (in case of wireless charging systems) may be available from the EV charging unit and EVSE.

Parallel battery bank modules and equivalent parallel DC sources, for example each of 8 kw, may be provided according to various embodiments to achieve the modular charging system for small EVs (for example cars or taxis). For higher battery pack requirements (for example buses or trucks), the same EVSE may be configured in multiple of 16 kw DC sources to achieve the modularity.

A maximum number of parallel modules may be decided based on the power requirements of a vehicle and easy maintainability.

According to various embodiments, an EVSE smart charge control unit (or device) may have the flexibility and configurability to support multiple voltage and the power requirements for different types of vehicles. The system may be usable with more voltage and less current to reduce the stress on the components.

A communication interface, for example CAN (Controller Area Network) may be utilized for exchange of messages between the smart charging units of EV and EVSE.

For example, voltages for an 8 kWh battery bank may be as follows: if the battery bank voltage is 120 VDC, the current may be 67 A, which may be in an acceptable range of current without degrading the battery life when compared to Level 3 DC with 500V and 100 A charging.

If the source voltage is 230 VAC, then an individual battery bank DC voltage may be 325V and a current may be 24.6 A which may again be in an acceptable range of current without degrading the battery life.

An example timing for charging (for example assuming a 1 C type of charging) may be as follows: with four 8 kW modules, a 32 kWh battery pack may be charged in 1 hour and it may be charged to 50% in 0.5 hour. So a 0.5 hour charge may provide about 64 miles of drive range.

In the following, further details of systems and operation according to various embodiments will be described.

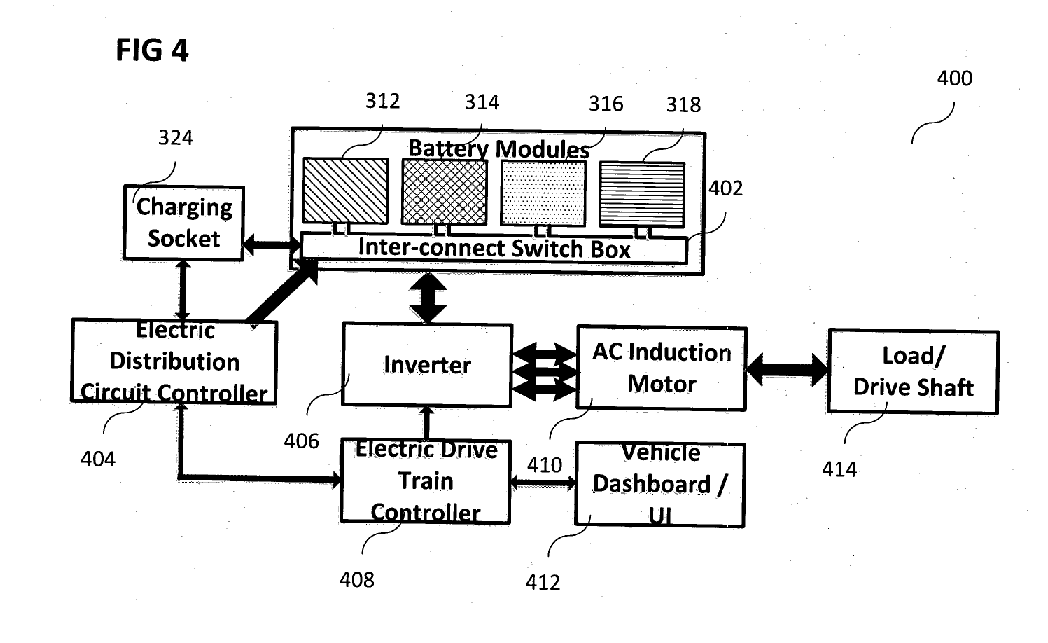

FIG. 3 shows an illustration 300 of an arrangement of an on board system and an EVSE according to various embodiments. As can be seen, such an arrangement offers room for independent charging, health monitoring, maintenance and replacement of any of the components used in the circuit. FIG. 3 shows a block diagram of an on board system 302 (for example illustrating an e-taxi on-board source routing) and of a charging station 304 of an electric vehicle.

The quick charging system according to various embodiments as shown in FIG. 3 may include modules as described in more detail in the following.

The on-board modules may include: a charging enabler system (Electronic Control and Power Distribution Circuit) 322; multiple rechargeable energy storage (RES) systems (for example battery modules) 312, 314, 316, 318; an inverter 320; and interface connectors 324.

The on-board system may be considered to provide that the Energy storage system (ESS) is properly configured and efficiently charged. It may also include the features required for management of Energy storage systems.

The off-board-charging station/EVSE module may include: multiple charging converter modules 328, 330, 332, 334; a main electronic control unit 344; sub electronic control units 336, 338, 340, 342; an energy storage system (which may be optional and is not shown in FIG. 3); and interface connectors 326.

The off-board DC charging system according to various embodiments may be configured to provide that the charging system supplies the required energy for each individual on-board module; to meet the desired charging requirements of the corresponding on-board module.

For example, each battery module of the on-board module may have a dedicated charging converter module and sub-electronic control unit in the off-board DC charging system (for example, battery module 312 may be taken care of by charging converter module 328 and sub electronic control unit 336; battery module 314 may be taken care of by charging converter module 330 and sub electronic control unit 338; battery module 316 may be taken care of by charging converter module 332 and sub electronic control unit 340; battery module 318 may be taken care of by charging converter module 334 and sub electronic control unit 342). It will be understood that although four battery modules (and accordingly four charging converter modules and four sub electronic control units) are illustrated in FIG. 3, any number of battery modules (and a corresponding number of charging converter modules and sub electronic control units) may be provided.

Furthermore, FIG. 3 illustrates parts 306, 308, 310 of the drivetrains of the EV (for example a motor (or generator) 308, and wheels 306, 308).

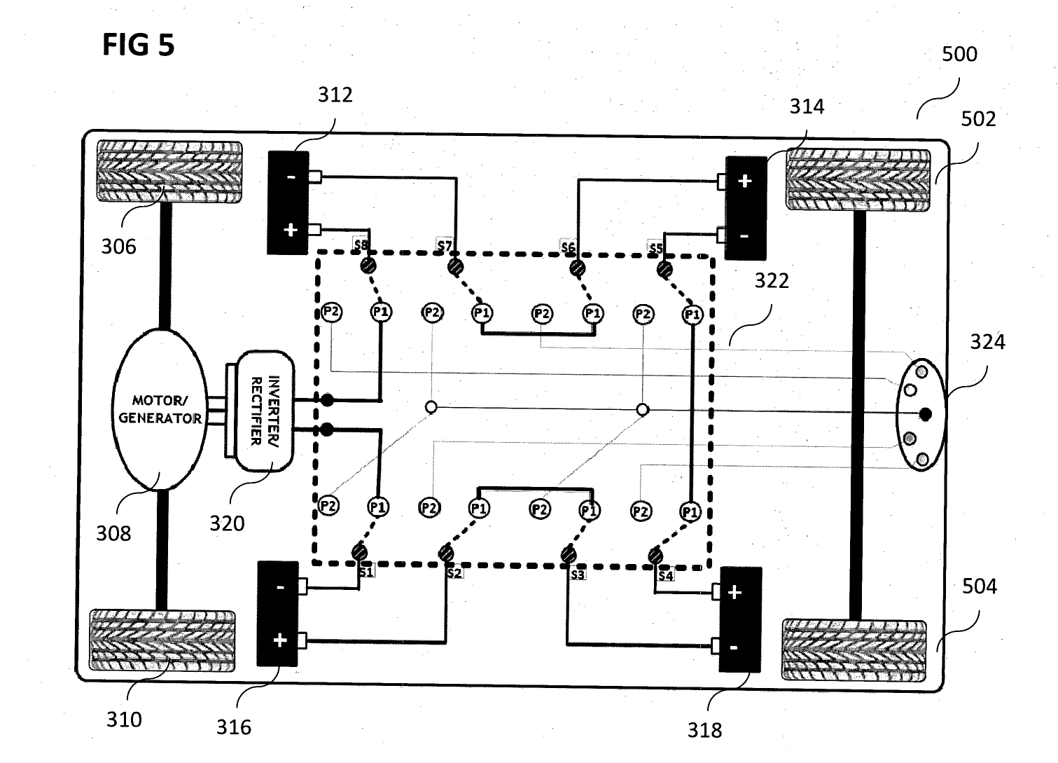

FIG. 4 shows a further illustration of an on-board module 400 according to various embodiments. Various portions of the on-board module 400 may be identical or similar to the on-board module 302 illustrated in FIG. 3, so that the same reference signs may be used and duplicate description may be omitted.

The operation of a vehicle may be divided into two modes. (1) Normal mode may be the drive mode and (2) Charging mode may be the mode when the vehicle is stationary and getting charged. The normal mode may cater to the normal driving needs of the electric vehicle and the charging mode may provide the necessary charging interface and signals for charging the on-board battery system.

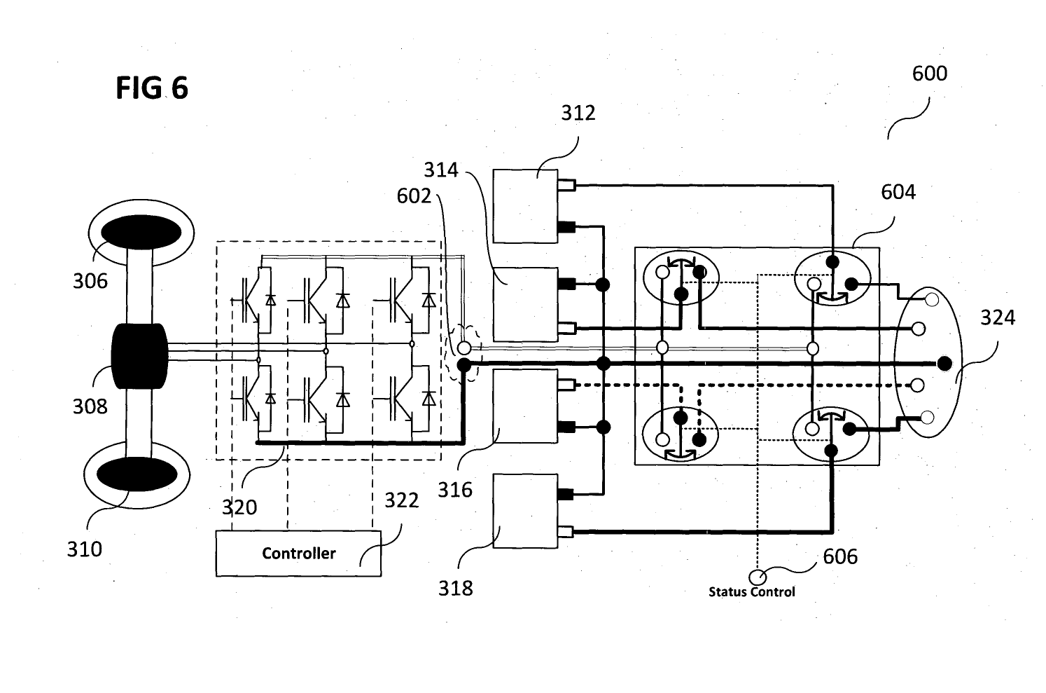

FIG. 5 shows an EV 500 according to various embodiments. Various portions of the EV 500, for example the on-board module of the EV 500, shown in FIG. 5, may be identical or similar to what is illustrated in FIG. 3, so that the same reference signs may be used and duplicate description may be omitted. Besides driven wheels 310, 312, FIG. 5 illustrates undriven wheels 502, 504. It will, however, be understood, that any of the wheels of a car may be a driven wheel or an undriven wheel.

By default, the EV 500 may be in the normal mode. When the EV 500 is in the normal mode, the ECPDU (Electronic control and power distribution unit) 322 may configure the inter-bank module connections based on driving needs for normal operation of the system, for example. The switches (S1 through S8) may be in position P1, between the battery modules 312, 314, 316, 318, as shown in FIG. 5. This may provide that the battery banks of the on-board system to be connected serially to provide the voltage and the power required by the EV drive system.

FIG. 6 shows an EV 600 according to various embodiments. Various portions of the EV 600 shown in FIG. 6 may be identical or similar to what is illustrated in FIG. 3 or FIG. 5, so that the same reference signs may be used and duplicate description may be omitted.

FIG. 6 shows an alternative arrangement of modular on-board charging system according to various embodiments, wherein only the parallel combination is configurable. In this case, the HV DC (High Voltage Direct Current) bus 602 may be connected to the inverter system 320 to provide the voltage and the power required by the EV drive system. During charge mode, status control signal (for example provided at a status control signal port 606) may be used to configure the interconnections so that each of the battery modules (312, 314, 316, 318) are connected to the respective positive connection points of 324. The block 604 depicts one of the configurations of the ECPDU where in only the parallel connections are configurable. FIG. 6 also depicts the connection of HV DC bus to the drive train.

A battery monitoring system (BMS) may be provided in the on-board system to monitor the status of the battery system continuously.

When the EV system is first turned on, the ECPDU may communicate with the BMS to check the status of the each cell, compute the age of the individual battery module or check for the faulty module. The ECPDU may configure the interconnect switches to connect or disconnect the individual battery bank from the drive system through the switch in event of failure of single bank.

The drive system may still be operational with reduced driving range. It may communicate this information to the Electric Drivetrain Controller Unit (EDCU). The EDCU may update the display through an alert message, so that user is notified of the Battery module status and driving range.

The EDCU may communicate with the BMS periodically and may obtain the SOC of the battery modules. The EDCU may determine the range (or distance) that may be traveled with the available SOC and may update the user display. The user display may have parameters to display the “Battery charge” available and “Estimated range” at the current driving speed.

The user may put the EV system into charging mode when the batteries need to be recharged.

A dash board interface may provide the user with a charging button to put the EV in the charging mode. The user needs to plug in the EV on-board connector with interface cord of the EVSE and activate the charging button.

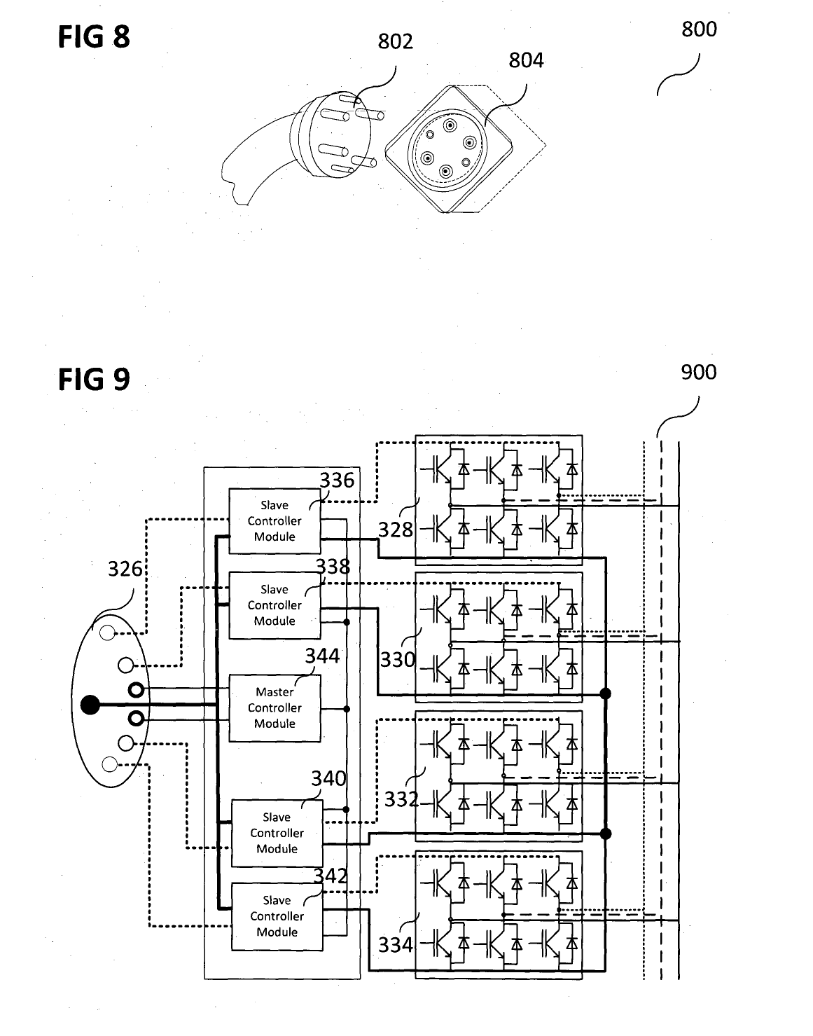

FIG. 9 shows a charger system 900 according to various embodiments. Various portions of the charger system 900 shown in FIG. 9 may be identical or similar to what is illustrated in FIG. 3, so that the same reference signs may be used and duplicate description may be omitted.

The charger system 900 may include a main electronic control unit 344 (for example a charging system Electronic Control Unit (CSECU)) and multiple slave electronic control units 336, 338, 340, 342. The charger system 900 may furthermore include multiple converter modules 328, 330, 332, 334 which may convert three phase AC to DC.

FIG. 7 shows an EV 700 according to various embodiments. Various portions of the EV 700 shown in FIG. 7 may be identical or similar to what is illustrated in FIG. 3 or FIG. 5, so that the same reference signs may be used and duplicate description may be omitted.

When the EV is in the charge mode, the ECPDU may configure the electronic switches of the battery packs so that the switches (S1 through S8) will be in position P2, and the batteries may connected in parallel as shown in FIG. 7. This configuration may enable individual modules to be charged independently by the Charging System/EVSE. The battery module connections, to the charger socket are also illustrated in FIG. 6.

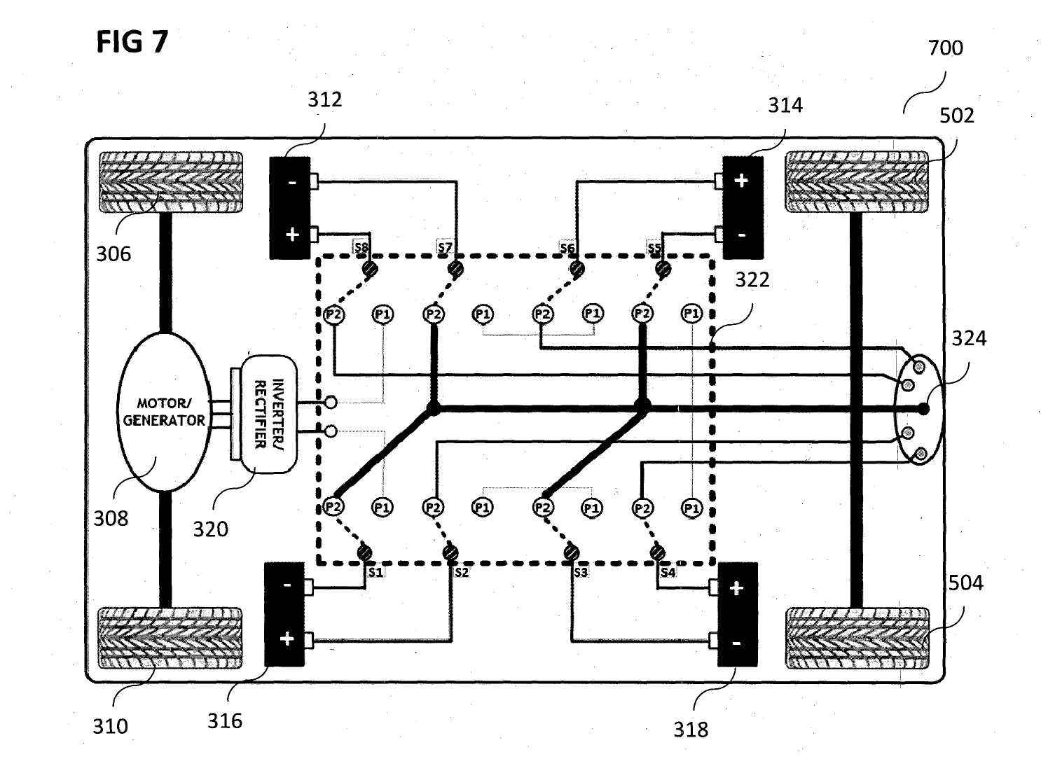

FIG. 8 shows a plugging system 800 according to various embodiments. For plugged-in charging, FIG. 8 shows the possible connectors for EVSE 802 and on-board unit 804.

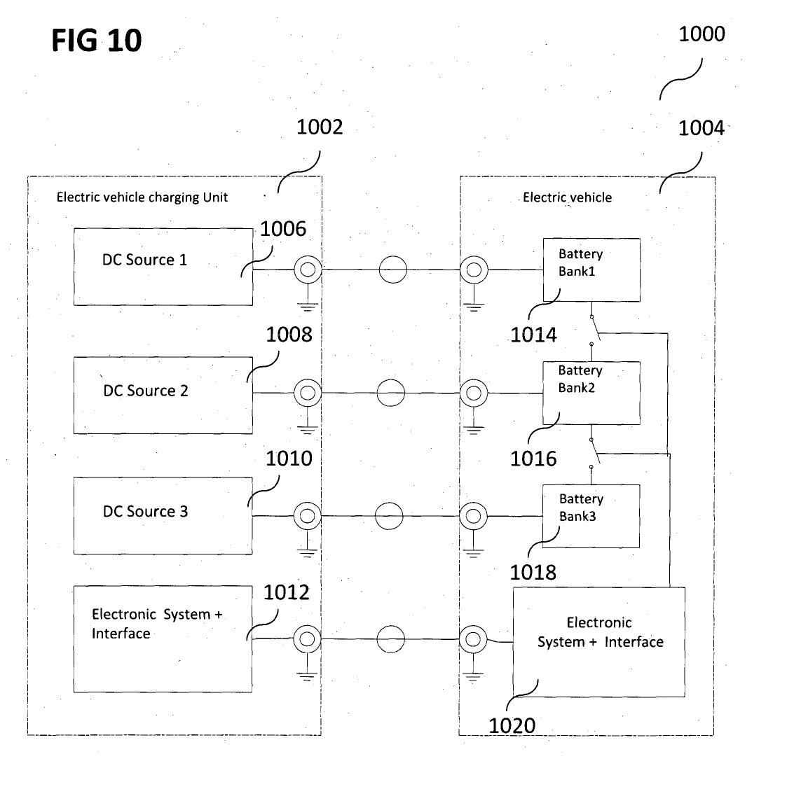

When the interface cord 802 is plugged to the EV Charge socket 804, each battery module may be connected to the corresponding charger Module of EVSE as shown in FIG. 10.

FIG. 10 shows an illustration 1000 of a connection between an electric vehicle charging unit 1002 and an electric vehicle 1004 according to various embodiments. For example, a first DC source 1006 may be connected to a first battery bank 1014; a second DC source 1008 may be connected to a second battery bank 1016; a third DC source 1010 may be connected to a third battery bank 1018; and an electronic system and interface 1012 of the EV charging unit 1002 may be connected to an electronic system and interface 1020 of the EV 1004.

Once the physical connection is established, the on-board electronic control and power distribution unit (ECPDU) may communicate with the EDCU to get the information on voltage and/or power requirements. The ECPDU may communicate with BMS for battery parameters. The ECPDU may communicate the information regarding these parameters to the CSECU through a predefined protocol.

The protocol may define the information that is communicated between the on-board system (ECPDU) and the charging station module.

At the charger station, the communication protocol may be used to collect the information from the on-board system. The information from the EV ECPDU may include for example the SOC and/or SOH, of each individual cell and other required parameters.

The charger system main electronic control unit may include a method to determine the rate of charging (1 C or 2 C) for each module.

Once the initial inter-communication and computation is completed, the EV ECPDU may make the inter-switch re-connections/disconnections of the battery module based on the computation and logical methodology.

The charging system electronic control unit (CSECU) may then transmit the message to the slave electronic control units to configure the individual charge converter modules to charge at the rate determined by main control unit. When the slave unit successfully does the configuration, it may communicate to the main control unit, which in turn communicates to the on-board system with data packet conveying that a charging process is initiated. The charging process may then take place.

The CSECU may communicate periodically with the ECPDU to determine the status of charge of each on-board battery module/cell. The CSECU may display the progress of charge of each module on user interface unit.

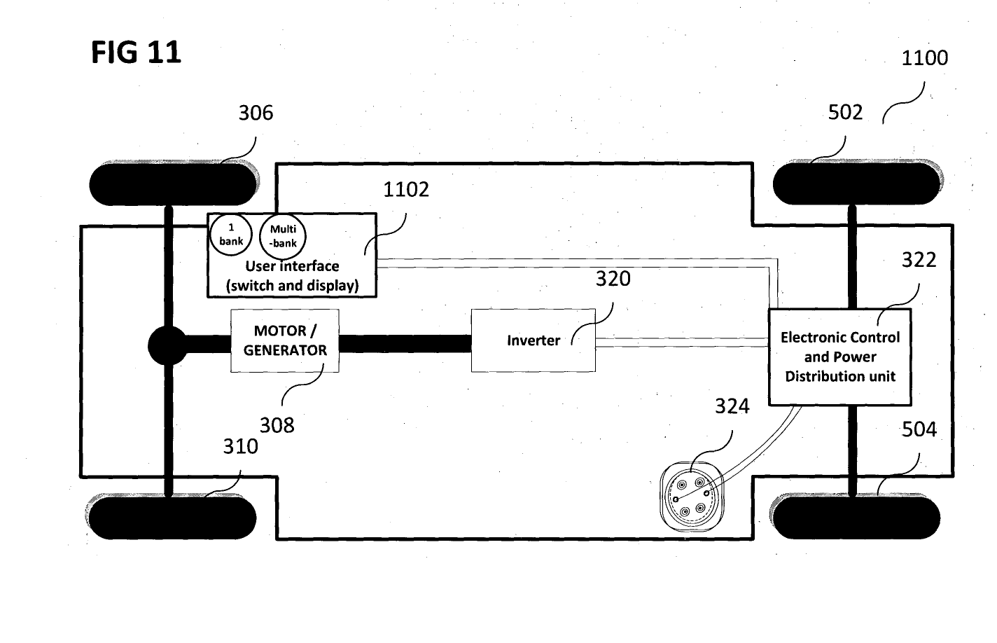

FIG. 11 shows an EV 1100 according to various embodiments. Various portions of the EV 1100 shown in FIG. 1100 may be identical or similar to what is illustrated in FIG. 3 or FIG. 5, so that the same reference signs may be used and duplicate description may be omitted.

During the charging process, the EV ECPDU may communicate periodically with the CSECU to get information regarding the number of banks to be charged and the rate of charging. The ECPDU may interact with a user interface unit 1102 and the EV ECU may update the display accordingly. The user may be notified with individual battery bank charging information, driving range and added driving range by charging single or multiple banks.

The user interface 1102 may also have provisions to display the SOH of individual battery banks upon selection of appropriate menu.

When the charging of the corresponding on-board battery module is complete, the CSECU may transmit the message to the slave control unit to cut-off the power from the respective Charging module. The CSECU may display the completion of charge of module on user interface unit.

When the charging of all the on-board modules is complete, the CSECU may communicate the charge complete message through the data packet to the on-board ECPDU. The data packet may include the information such as:
SOC of each module before charging;
SOC of each module after charging; and
Rate of Charge.

With the kind of on-board EVSE arrangement and inter communication as described above, the system according to various embodiments may allow mixing battery modules that are aged differently, i.e. the individual modules may be new battery modules (for example replaced for faulty battery module) or previously used battery packs.

Any individual battery bank may be disconnected from the drive system through the same switch in event of failure of single bank. However the drive system may be still operational with reduced driving range. The user may be notified of the driving range through the display alert.

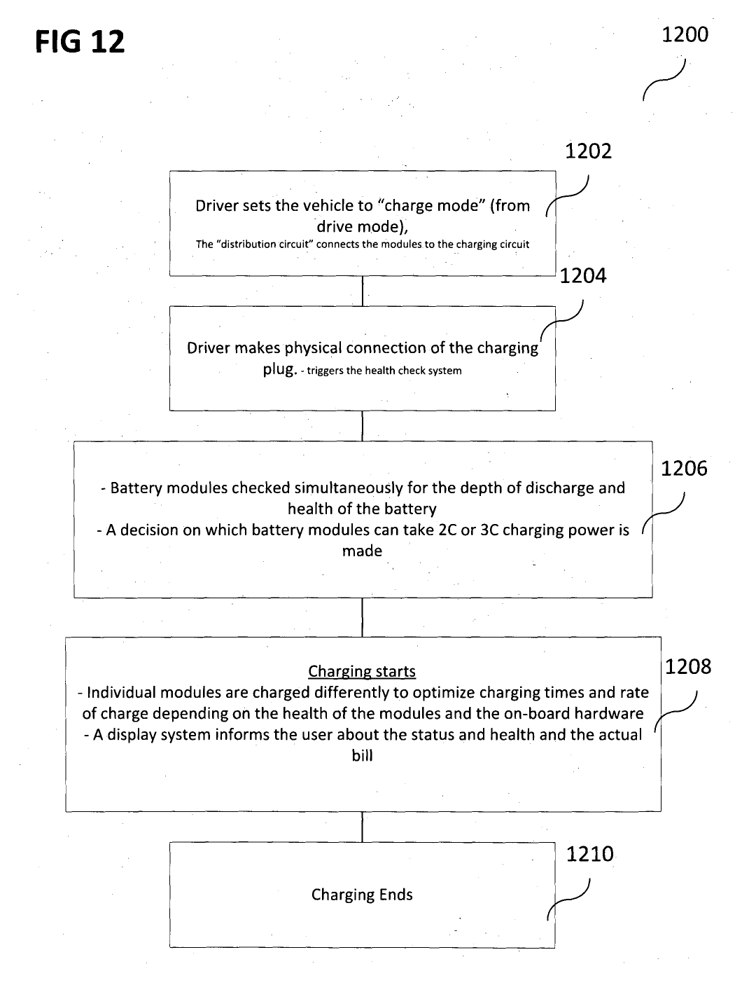

FIG. 12 shows a flow diagram 1200 illustrating a charging method according to various embodiments. In 1202, the driver may set the vehicle to “charge mode” (for example from drive mode), and the distribution circuit may connect the modules to the charging circuit. In 1204, the drive may make physical connection of the charging plug, which may trigger the health check system. In 1206, the battery modules may be checked simultaneously for the depth of discharge and health of the battery, and a decision on which battery modules can take 2 C or 3 C charging power is made. In 1208, charging may start. Individual modules may be charged differently to optimize charging times and rate of charge depending on the health of the modules and the on-board hardware. A display system may inform the user about the status and health and the actual bill. In 1210, charging may end.

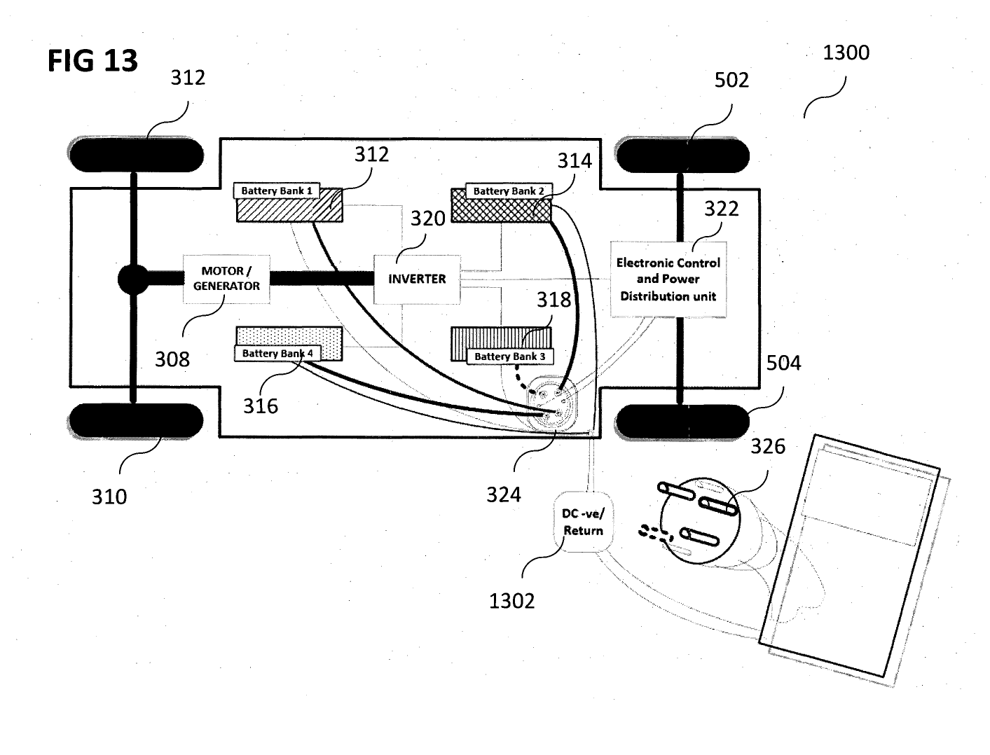

FIG. 13 shows an illustration 1300 of a connection according to various embodiments. FIG. 13 shows an EV 1300 according to various embodiments. Various portions of the EV 1300 shown in FIG. 13 may be identical or similar to what is illustrated in FIG. 3 or FIG. 5, so that the same reference signs may be used and duplicate description may be omitted. For plugged-in charging, FIG. 13 shows a possible connection configuration of EVSE and on-board unit. The connection of DC return 1302 between the on-board vehicle and EVSE may be separated from the main connector to reduce the weight of main connector. The DC return connection 1302 may be automatically established through an automated mechanism when the interface cord between EVSE and the on-board connector is connected.

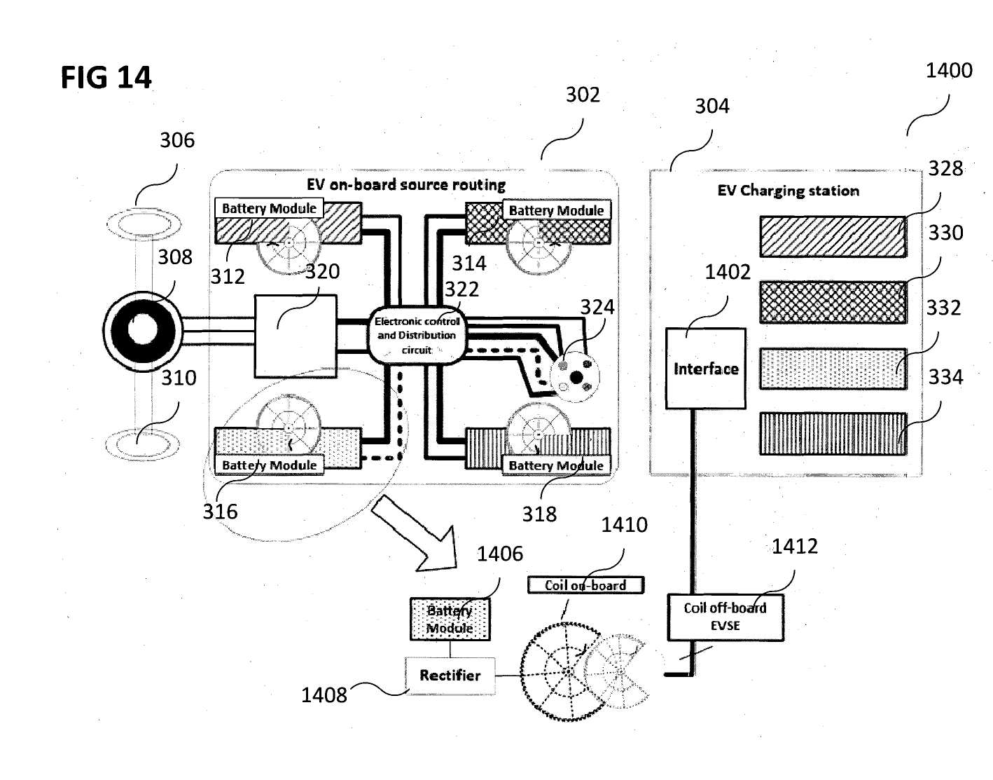

FIG. 14 shows an illustration 1400 of an arrangement of an on board system and an EVSE according to various embodiments. Various portions shown in FIG. 14 may be identical or similar to what is illustrated in FIG. 3, so that the same reference signs may be used and duplicate description may be omitted. The system arrangement as depicted in FIG. 14 allows for parallel wireless charging (for e.g. inductive charging) system. In this case there may be independent coil 1410 and converter/rectifier 1408 for charging each on-board individual battery module 1406 (for example corresponding to battery module 312, or battery module 314, or battery module 316, or battery module 318) and the corresponding coupling coil 1412 in the EVSE. There may be physical connection between EVSE and the EV only for communication of messages. Furthermore, an interface 1402 between the EV charging station 304 and the coil off-board EVSE 1412 may be provided. The charging process order may be similar to the flow described in FIG. 12.

The system arrangement as depicted in FIG. 14 may allow for combining the plug-in charging for some battery banks and wireless charging for other banks. There may be a protocol for exchange of messages between EVSE and ECPDU regarding the type of charging for each individual battery modules. ECPDU may perform the necessary configuration of inter-switch and power connections of the battery module for the on-board unit. The electronic interface unit in the EVSE may also make the necessary system configuration according to exchange of messages.

Superconductors may be used for interconnection between the battery banks and between the inverter and battery banks for higher efficiency. Super conductors may also be used in EVSE to achieve efficiency and no power losses.

The devices and methods according to various embodiments may provide a time reduction for charging. Assuming a 1 C charging, e.g. LEVEL 2 charging with 19.2 kW from public charging unit for a 24 kWh battery pack takes about 1.25 hr. LEVEL 2 charging with 7.2 kW from home charging facility for 24 kWh battery pack takes about 3.34 hr.

With the system according to various embodiments, charging a 24 kWh battery pack may take less than one hours [(24/8)/4]; assuming 24 kWh battery pack, 8 kw charging modules and 4 module system.

The devices and methods according to various embodiments may provide an increased availability of the EV system for individual users, public transport vehicles such as buses and taxis; having more EVs may result in reduced emission and environment friendly transport systems.

The devices and methods according to various embodiments may provide an extension of lifetime of battery and components of the charging system.

According to various embodiments existing components and connectors may be used with the re-organization according to various embodiments.

The devices and methods according to various embodiments may easily be retrofitted to existing systems.

According to various embodiments, the cost of the system may get reduced due to multiple modules of the same kind instead of a single large system.

The devices and methods according to various embodiments may provide a redundant and fault tolerant system which may be in-built with this architecture. There may be no down-time with this architecture.

The devices and methods according to various embodiments may provide a modular system which may aid in simple and easy maintenance of both the on-board systems and charging stations.

The devices, systems, and methods according to various embodiments may be commercially applicable at least for the following reasons. Various embodiments may provide an approach that has the technique to improve the charging times. Various embodiments may be used for charging needs (on-board charging system and electric vehicle supply equipment charging station) of all kind of electric vehicles that are in the product portfolio of EV companies, like for example electric taxis, private electrical cars, electric buses, auxiliary transport systems, or electric trucks.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A battery charging device comprising:
a first determination circuit configured to determine a state of a first battery of an electric vehicle;
a second determination circuit configured to determine a state of a second battery of the electric vehicle;
a first charging circuit configured to charge the first battery based on the determined condition of the first battery;
a second charging circuit configured to charge the second battery based on the determined condition of the second battery;
a plurality of connection points for wired charging of at least one of the first battery or the second battery; and
a plurality of coils for wireless charging of at least one of the first battery or the second battery.

2. The battery charging device of claim 1,
wherein the state of the first battery comprises at least one of a state of health of the first battery or a state of charge of the first battery; and
wherein the state of the second battery comprises at least one of a state of health of the second battery or a state of charge of the second battery.

3. The battery charging device of claim 1,
wherein the first determination circuit and the second determination circuit are configured to operate simultaneously.

4. The battery charging device of claim 1,
wherein the first charging circuit and the second charging circuit are configured to operate simultaneously.

5. The battery charging device of claim 1,
wherein the first charging circuit is configured to charge the first battery through a wired connection; and
wherein the second charging circuit is configured to charge the second battery through a wireless medium.

6. The battery charging device of claim 1,
wherein the first charging circuit is configured to determine a first charging power based on the determined condition of the first battery and further configured to charge the first battery with the determined first charging power; and
wherein the second charging circuit is configured to determine a second charging power based on the determined condition of the second battery and further configured to charge the second battery with the determined second charging power; and

[symbol]

7. The battery charging device of claim 1,
wherein the first charging circuit and the second charging circuit are configured to operate with different charging power.

8. The battery charging device of claim 1, further comprising:
a first connector configured to provide a connection between the first battery and the first charging circuit; and
a second connector configured to provide a connection between the second battery and the second charging circuit.

9. The battery charging device of claim 1, further comprising:
a main control circuit configured to control the first determination circuit, the second determination circuit, the first charging circuit, and the second charging circuit.

10. The battery charging device of claim 1,
wherein the first charging circuit comprises a first converter circuit configured to convert an input electric source to a charging signal for the first charging circuit; and
wherein the second charging circuit comprises a second converter circuit configured to convert the input electric source to a charging signal for the second charging circuit.

11. The battery charging device of claim 1, further comprising:
a first subcontrol circuit configured to control the first determination circuit and the first charging circuit; and
a second subcontrol circuit configured to control the second determination circuit and the second charging circuit.

12. (canceled)

13. (canceled)

14. (canceled)

15. (canceled)

16. A battery charging method comprising:
determining a state of a first battery of an electric vehicle;
determining a state of a second battery of the electric vehicle;
charging the first battery based on the determined condition of the first battery;
charging the second battery based on the determined condition of the second battery;
providing connections using a plurality of connection points for wired charging of at least one of the first battery or the second battery; and
providing connections using a plurality of coils for wireless charging of at least one of the first battery or the second battery.

17. (canceled)

18. (canceled)

19. (canceled)

20. (canceled)

21. (canceled)

22. (canceled)

23. (canceled)

24. (canceled)

25. (canceled)

26. The battery charging method of claim 16, further comprising:
controlling the first determination circuit and the first charging circuit using a first subcontrol circuit; and
controlling the second determination circuit and the second charging circuit using a second subcontrol circuit.

27. The battery charging method of claim 16, further comprising:
switching a configurable interconnection between the first battery and the second battery.

28. (canceled)

29. (canceled)

30. (canceled)

31. A battery system comprising:
a first battery;
a second battery;
a configurable interconnection;
a switching circuit configured to switch the configurable interconnection between the first battery and the second battery;
a plurality of connection points for wired charging of at least one of the first battery or the second battery; and
a plurality of coils for wireless charging of at least one of the first battery or the second battery.

32. The battery system of claim 31, further comprising:
a battery charging device comprising:
a first determination circuit configured to determine a state of a first battery of an electric vehicle;
a second determination circuit configured to determine a state of a second battery of the electric vehicle;
a first charging circuit configured to charge the first battery based on the determined condition of the first battery;
a second charging circuit configured to charge the second battery based on the determined condition of the second battery;
a plurality of connection points for wired charging of at least one of the first battery or the second battery; and
a plurality of coils for wireless charging of at least one of the first battery or the second battery.

33. The battery system of claim 31, further comprising:
a memory configured to store instructions for controlling the switching circuit.

34. The battery system of claim 31, further comprising:
a display interface configured to display a status of the first battery, a status of the second battery, and a status of the switchable interconnection.

35. The battery system of claim 31, further comprising:
a keyboard interface configured to receive user input for individually controlling charging of the first battery and charging of the second battery.

36. The battery system of claim 31,
wherein the switching circuit comprises digital control logics.

37. (canceled)

38. (canceled)

39. (canceled)

40. (canceled)

41. (canceled)

42. (canceled)
